(19) United States
(12) Patent Application Publication
(10) Pub. No.: US 2020/0364832 A1
(43) Pub. Date: Nov. 19, 2020

(54) PHOTOGRAPHING METHOD AND APPARATUS

(71) Applicant: SZ DJI TECHNOLOGY CO., LTD, Shenzhen City (CN)

(72) Inventors: Pan HU, Shenzhen (CN); Wen ZOU, Shenzhen (CN); Zisheng CAO, Shenzhen (CN)

(73) Assignee: SZ DJI TECHNOLOGY CO., LTD., Shenzhen City (CN)

(21) Appl. No.: 16/534,677

(22) Filed: Aug. 7, 2019

Related U.S. Application Data
(63) Continuation of application No. PCT/CN2019/086914, filed on May 14, 2019.

(51) Int. Cl. G06T 3/60; G06T 3/40; G06T 7/80; G06T 7/00; G06T 7/20

(52) U.S. Cl. CPC G06T 3/60; G06T 3/40; G06T 7/20; G06T 7/97; G06T 7/80

(57) ABSTRACT

Photographing methods and photographing apparatuses are provided. In one exemplary implementation, a photographing method may include automatically triggering a photographing operation of a camera to capture an image using a combination of software and hardware, automatically correcting the captured image to generate a corrected image, and outputting the corrected image. The exemplary photographing method may provide automatic photographing having less or no user operations relative to previous photographing methods and apparatuses.

### CROSS-REFERENCE TO RELATED PATENT APPLICATIONS

This application is a continuation of International Application No. PCT/CN2019/086914, filed May 14, 2019, which is hereby incorporated by reference in its entirety.

### TECHNICAL FIELD

The present disclosure relates to photographing technologies and, more particularly, to a photographing method and apparatus.

### BACKGROUND

An action camera generally has high requirements on compactness, portability, and proofing. Due to the portability requirement of the action camera, the action camera generally has a small screen and a few buttons for a user to interact with. As such, the user cannot perform a series of operations on the action camera as easily and friendly as on a professional camera or a mobile phone to complete the image framing and composition, and hence, users rarely use the action camera to photograph images in a manual manner.

However, the cameras on the market are generally lack of advanced auto-trigger and auto-composition (also referred to as auto-framing) functions. The auto-trigger function is limited to a timed photographing or time-lapse photographing. The cameras do not include advanced detection and identification components, such as sensors and processors. The user needs to perform more operations to realize the composition and photographing, according to a three-point line and a horizontal line on a live view video screen, or lower-level image information, such as a face position frame, a color histogram of the scene, and a focus. Therefore, the effect of automatic composition is not achieved.

Therefore, the motion camera having the auto-trigger, auto-composition, or the like, is needed for obtaining better quality images without the need of any operation performed by the user.

### SUMMARY

In accordance with the disclosure, there is provided a photographing method including automatically triggering a photographing operation of a camera to capture an image using a combination of software and hardware, automatically correcting the captured image to generate a corrected image, and outputting the corrected image.

Also in accordance with the disclosure, there is provided a photographing apparatus including a camera, a memory storing instructions, and a processor coupled to the memory. The processor is configured to automatically trigger a photographing operation of a camera to capture an image using a combination of software and hardware, automatically correct the captured image to generate a corrected image, and output the corrected image.

### BRIEF DESCRIPTION OF THE DRAWINGS

FIGS. 1A to 1C schematically show application scenarios of a photographing apparatus according to embodiments of the disclosure.

FIG. 2 is a schematic diagram of a photographing apparatus according to embodiments of the disclosure.

FIG. 3 is a flow chart of a rotation correction process implemented by the photographing apparatus of FIG. 2.

FIG. 4 is a flow chart of an image processing process implemented by the photographing apparatus of FIG. 2.

FIGS. 5A to 5D show a flow chart of a process implemented by the photographing apparatus of FIG. 2.

FIG. 6 is a schematic diagram of another photographing apparatus according to embodiments of the disclosure.

FIG. 7 is a schematic diagram of another photographing apparatus according to embodiments of the disclosure.

FIG. 8 is a schematic diagram of another photographing apparatus according to embodiments of the disclosure.

FIG. 9 is a flow chart of a photographing method according to embodiments of the disclosure.

FIG. 10 is a flow chart of another photographing method according to embodiments of the disclosure.

FIG. 11 is a flow chart of another photographing method according to embodiments of the disclosure.

FIG. 12 is a flow chart of another photographing method according to embodiments of the disclosure.

FIG. 13 is a flow chart of another photographing method according to embodiments of the disclosure.

### DETAILED DESCRIPTION OF THE EMBODIMENTS

Hereinafter, embodiments consistent with the disclosure will be described with reference to the drawings, which are merely examples for illustrative purposes and are not intended to limit the scope of the disclosure. Wherever possible, the same reference numbers will be used throughout the drawings to refer to the same or like parts.

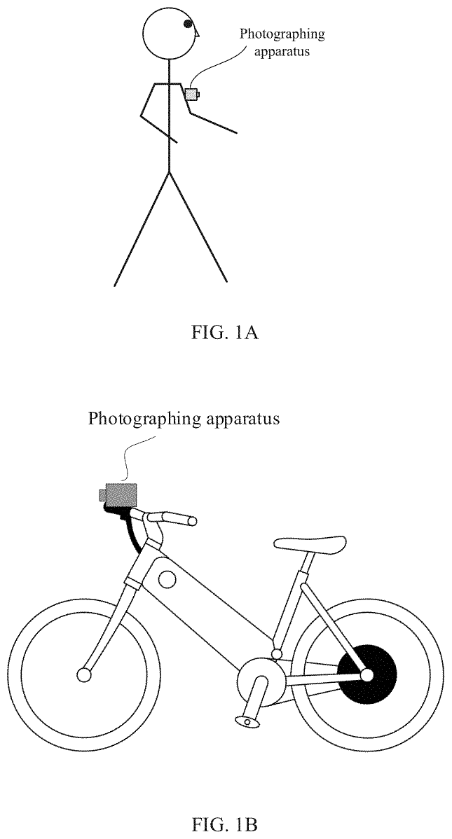

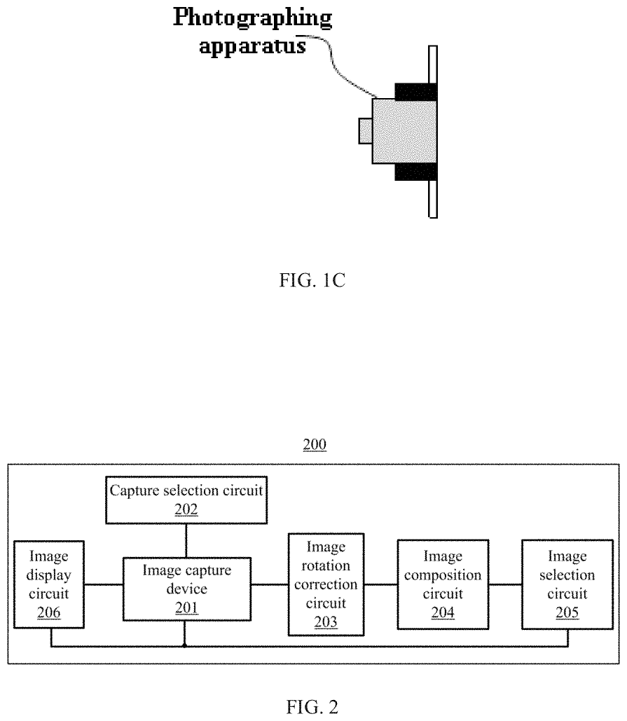

The present disclosure provides a photographing apparatus having the auto-trigger, auto-rotation-correction, auto-composition, and/or auto-image-selection functions, thereby realizing automatic photographing with less or no user operations. FIGS. 1A to 1C schematically show example application scenarios of the photographing apparatus consistent with the disclosure. As shown in FIG. 1A, a user can wear the photographing apparatus directly on his body or arm or indirectly on his body or arm via another accessory, such as a wrist band or the like. For example, when the user is outside and wears the photographing apparatus, the photographing apparatus can automatically shoot aesthetically pleasing images during a tour. After finishing the tour, the user can view the images shot automatically by the photographing apparatus and obtain aesthetically pleasing images. In some embodiments, the photographing apparatus can be mounted at a movable object (such as a bicycle shown in FIG. 1B or a car) for automatic shooting, such that a wide range of change of the scene or special shooting needs can be satisfied. In some other embodiments, as shown in FIG. 1C, the photographing apparatus can be arranged at or fixedly attached to a static object, such as a wall, a table, or the like. In this scenario, the photographing apparatus is not moving, but the photographing apparatus can shoot images of changing content in the scene and capture life's moments.

FIG. 2 is a schematic diagram of an example photographing apparatus 200 consistent with the disclosure. As shown in FIG. 2, the photographing apparatus 200 includes a camera 201, a capture selection circuit 202 coupled to the image capture device 201, an image rotation correction circuit 203 coupled to the image capture device 201, an image composition circuit 204 coupled to the image rotation correction circuit 203, an image selection circuit 205 coupled to the image composition circuit 204 and the image capture device 201, and an image display circuit 206 coupled to the image composition circuit 204 and the image capture device 201.

The image capture device 201 can be a camera, a camcorder, a photosensor, or the like. The image capture device 201 can include a camera lens, an image sensor, an image processing chip, a memory, a screen, an interface, and/or the like. In some embodiments, the camera lens can include a wide-angle lens with a field of view (FOV) of, for example, more than 120 degrees. In some other embodiments, the camera lens can include a plurality of lenses. The image sensor can include, for example, a charge-coupled device (CCD) sensor or a complementary metal-oxide semiconductor (CMOS) sensor. The image processing chip can be coupled to the image sensor. The image capture device 201 can capture image through the camera lens and the image sensor, and then input the captured image into the image processing chip through the image sensor. The image processing chip can process the image, for example, by performing noise reduction, color correction, format conversion (e.g., from RGB to YUV), scaling, or the like, on the image. The image processing chip can also be configured to control the camera lens and/or the image sensor, for example, adjust the 3A parameters, i.e., automatic exposure (AE), auto white balance (AWB), autofocus (AF). The image processing chip may be, for example, a digital signal processing (DSP) chip. The memory can be configured to store, either temporarily or permanently, the captured image data. The interface can include any kind of electric interface, such as a Universal Serial Bus (USB) interface, an Institute of Electrical & Electronics Engineers 1394 (IEEE 1394) interface, or the like, for image transmission.

The capture selection circuit 202 can include, for example, a microprocessor, a portion of a microprocessor, an application-specific integrated circuit (ASIC), or a portion of an ASIC, and can be configured to automatically trigger a photographing operation of the image capture device 201 to capture an image of a current scene using a combination of software and hardware. In some embodiments, the capture selection circuit 202 can trigger the photographing operation once an object with a specific semantic is detected in the current scene. The specific semantic can include, but is not limited to, e.g., people, animal, face, or smile. For example, when a face is detected in the current scene, the capture selection circuit 202 can automatically trigger the photographing operation of the image capture device 201. Any object recognition algorithm can be used for detecting the object in the current scene, for example, a face recognition algorithm, which is not limited herein.

In some embodiments, the capture selection circuit 202 can trigger the photographing operation in response to a change of a depth of the current scene. The depth of the current scene can refer to, e.g., a focus distance of the camera 201, when the image capture device 201 faces the current scene. This can be, e.g., a distance from the image capture device 201 to an object in the current scene. In some embodiments, the depth of the current scene can be obtained via a depth sensor, for example, a Time of Flight (ToF) sensor. The change of the depth of the current scene can refer to that the depth of the current scene is different from the depth of a previous scene.

In some embodiments, the capture selection circuit 202 can trigger the photographing operation in response to a change of a focus of the current scene. The focus of the current scene can refer to a focus position of the image capture device 201, when the image capture device 201 focuses on an object in the current scene. In some embodiments, the focus of the current scene can be obtained via a focus sensor. The change of the focus of the current scene can refer to that the focus of the current scene is different from the focus of the previous scene.

In some embodiments, the capture selection circuit 202 can trigger the photographing operation through a voice command. For example, the capture selection circuit 202 can include a voice-user interface (VUI). A user can speak the voice command, and the VUI can detect the user's voice to capture the voice command and, for example, use a speech recognition algorithm to convert the voice command into text, such that the capture selection circuit 202 can trigger the photographing operation according to the converted text. The VUI can include, for example, a microphone configured to detect the user's voice and a processor (such as a microprocessor or an application specific integrated circuit (ASIC)) configured to convert the voice command.

In some embodiments, the capture selection circuit 202 can trigger the photographing operation through a control process. The control process can include a timer photographing, a time-lapse photographing, or the like. For example, the capture selection circuit 202 can trigger the photographing operation at a preset time using the timer photographing. As another example, the capture selection circuit 202 can trigger the photographing operation at a preset time period, for example, every 5 seconds, using the time-lapse photographing.

In some embodiments, the capture selection circuit 202 can trigger the photographing operation according to any combination of different criteria described above. For example, the capture selection circuit 202 can trigger the photographing operation at the preset time using the timer photographing, if the object with the specific semantic is detected at the preset time. As another example, the capture selection circuit 202 can trigger the photographing operation at a preset time period using time-lapse photographing, if the object with the specific semantic is detected at the preset time period.

The image rotation correction circuit 203 can include, for example, a microprocessor, a portion of a microprocessor, an ASIC, or a portion of an ASIC, and can be configured to receive the captured image from the image capture device 201 and automatically perform the rotation correction on the captured image. In some embodiments, the image rotation correction circuit 203 can obtain attitude information of the image capture device 201 through one or more attitude sensors mounted at or coupled to the image capture device 201, such as an inertial measurement unit (IMU). The attitude information can include yaw axis information, pitch axis information, and/or roll axis information of the image capture device 201. For example, the one or more attitude sensors, e.g., an IMU, can be arranged at the back side of the image sensor of the image capture device 201 and obtain the attitude information of the image capture device 201. The captured image can be rotated according to a difference between the attitude information of the image capture device 201 and a target attitude (such difference is also referred to as an “attitude difference”), such that attitude of the rotated image can be adjusted to the target attitude, as if the image were captured when the image capture device 201 is at the target attitude. Any method that is suitable for calculating the difference between the attitude information of the image capture device 201 and the target attitude can be employed.

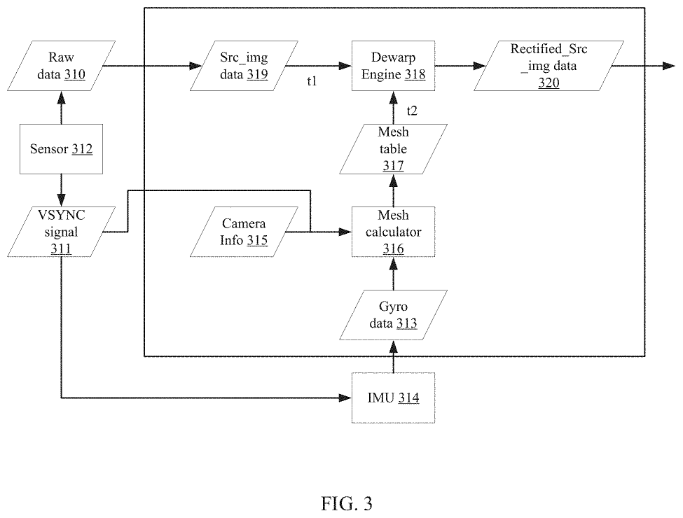

FIG. 3 is a flow chart of an example rotation correction process that can be implemented by, e.g., the photographing apparatus 200. For example, the rotation correction process shown in FIG. 3 can be implemented by the image rotation correction circuit 203 of the photographing apparatus 200. As shown in FIG. 3, raw data 310 of the captured image in a Bayer format and a VSYNC (vertical sync) signal 311 synchronized in each captured image is outputted by an image sensor 312, such as the image sensor of the image capture device 201. Gyro data 313 of an IMU 314 and the VSYNC signal 311 can be obtained by a driver circuit of the IMU 314. Each piece of gyro data 313 of the IMU 314 is labeled with a sequence number of the VSYNC signal 311 corresponding to each captured image. After parameters of the image capture device 201 (denoted as camera_info 315 in FIG. 3) and the gyro data 313 are obtained by a mesh calculator 316, a mesh table 317 can be calculated by the mesh calculator 316 according to a difference between the gyro data 313 and the target attitude (e.g., an attitude having a zero-degree yaw angle, a zero-degree roll angle, and a zero-degree pitch angle). The mesh table 317 can include a rotation matrix according to which the captured image can be rotated to generate the rotated image having the target attitude by a dewarp engine 318. The mesh calculator 316 can include, for example, a microprocessor, a portion of a microprocessor, an ASIC, or a portion of an ASIC. In some embodiments, the raw data 310 can be processed before sending to the dewarp engine 318. The processed image data is denoted as Src_img data 319 that is different from the raw data 310 of the captured image. It can be appreciated that the sequence number of the VSYNC signal 311 corresponding to the image data (e.g., Src_img data 319) sent to the dewarp engine 318 coincides with the sequence number of the VSYNC signal 311 in the mesh table, such that the captured image can be rotated to generate the rotated image having the target attitude. The image data of the rotated image is denoted by rectified-Src_img data 320 in FIG. 3. That is, a time point t2 when the Src_img data 319 is sent to the dewarp engine is earlier than a time point t1 when the mesh table is generated to ensure the captured image can be correctly rotated to generate the rotated image having the target attitude. In some embodiments, a rotation range can be set to cause the field of view (FOV) of the rotated image to be not smaller than an FOV threshold. The rotation range refers to a maximum degree of angle the image can be rotated. The FOV threshold can be determined according to actual requirements. The rotation range can include a rotation range in a yaw direction, a rotation range in a pitch direction, and/or a rotation range in a roll direction. If the difference between the attitude information of the image capture device 201 and the target attitude is greater than the rotation range, the captured image can be rotated according to the rotation range or the captured image can be maintained without any rotation. For example, if the difference between the attitude information of the image capture device 201 and the target attitude requires that the captured image be rotated for 20° in the roll direction but the rotation range in the roll direction is only 15°, then the captured image can be rotated for 15° in the roll direction or can remain not rotated.

In some other embodiments, a line with known tilt angle, such as a horizontal line or a vertical line, can be detected in the captured image to obtain a tilt angle in the roll direction, and the captured image can be rotated in the roll direction according to the tilt angle. Any method suitable for detecting the horizontal line or the vertical line can be employed. For example, a plurality of straight lines satisfying a difference in, e.g., color or contrast, between the sky and the ground in the captured image can be obtained. A curve fitting can be performed on each of these straight lines to obtain the horizontal line in the captured image. In some embodiments, the tilt angle can be obtained by calculating an angle between the horizontal line detected in the captured image and a straight line parallel to a width direction of the image capture device 201. In some other embodiments, the tilt angle can be obtained by calculating an angle between the vertical line detected in the captured image and a straight line parallel to a length direction of the image capture device 201. Sometimes, tilting of the captured image in the roll direction may result from the user's deliberate behavior and hence rotating the captured image in the roll direction is not needed. In some embodiments, a tilt threshold of the roll direction may be set, where a tilt angle in the roll direction greater than the tilt threshold of the roll direction may indicate that the user intentionally tilted the image capture device 201 to capture the image, and thus the captured image can be maintained without any rotation.

In some embodiments, a tilt angle in the pitch direction can be obtained through the one or more sensors mounted at or coupled to the image capture device 201, such as an angular sensor. For example, the one or more sensors, e.g., an angular sensor, can be arranged at the back side of the image sensor of the image capture device 201 and obtain the tilt angle of the image capture device 201 in the pitch direction. Sometimes, tilting of the captured image in the pitch direction may result from the user's deliberate behavior and hence rotating the captured image in the pitch direction is not needed. In some embodiments, a tilt threshold of the pitch direction may be set, where a tilt angle in the pitch direction greater than the tilt threshold of the pitch direction may indicate that the user intentionally tilted the image capture device 201 to capture the image, and thus the captured image can be maintained without any rotation. Since the action camera is generally worn by the user or arranged at a moving device, if the user does not actively participate in the composition during a photographing process, a tilt of an attitude of the camera occurs, for example, the photographed image has a projection deformation in a yaw direction, a pitch direction, or a roll direction. Therefore, a rotation correction needs to be performed on the photographed image to correct the tilt of the attitude. However, most of the cameras currently on the market need to use an auxiliary device, such as a gimbal, to realize the correction of the attitude during the photographing process, such that the user has to carry an additional device to complete the photographing, and the portability advantage of the action camera is deprived. Therefore, the photographing apparatus 200 having the auto-rotation-correction function can realize the correction of the attitude during the photographing process without need any auxiliary device, thereby realizing the portability advantage.

In some embodiments, the photographing apparatus 200 may further includes an image distortion correction circuit (not shown in FIG. 2) couple to the image rotation correction circuit 203 and/or the image capture device 201. The image distortion correction circuit can include, for example, a microprocessor, a portion of a microprocessor, an ASIC, or a portion of an ASIC, and can be configured to perform a distortion correction before or after rotating the captured image. The method for the distortion correction can be chosen according to a type of the distortion, and any suitable method can be employed. For example, a barrel-type distortion may exist in an image having a wide FOV. The method for correction of a barrel-type distortion can employ an even-order polynomial model, a polynomial model, a parameter-free model, a division model, and/or the like.

In some embodiments, the photographing apparatus 200 may include an image correction circuit instead of the image distortion correction circuit and the image rotation correction circuit 203. The image correction circuit can be configured to perform both the distortion correction and the rotation correction on the captured image.

An ultra-wide-angle lens used by the action camera allows to photograph an image having a wide FOV in a moving scene. However, due to an optical distortion caused by the ultra-wide-angle lens, the edges of the photographed image have severe distortion and compression. Although a certain range of distortion can be corrected by using distortion correction, a visual effect of the image after distortion correction is still unacceptable. Therefore, the photographing apparatus 200 having the distortion correction function can obtain the image having a better visual effect. The image composition circuit 204 can include, for example, a microprocessor, a portion of a microprocessor, an ASIC, or a portion of an ASIC, and can be configured to receive the rotated image from the image rotation correction circuit 203 and automatically compose the rotated image to generate the corrected image. In some embodiments, the image composition circuit 204 can be configured to compose the rotated image based on a saliency detection and a composition rule. The composition rule can include a central composition rule, a triad composition rule, a horizontal line composition rule, a symmetric composition rule, a diagonal composition rule, and/or the like.

For example, the image composition circuit 204 can detect a salient object in the rotated image. The position and size information of the salient object in the rotated image can be obtained. The rotated image can be cropped to obtain a composed image, according to the composition rule and the position and size information of the salient object. For example, if the composition rule is the central composition rule, then the rotated image can be cropped to place the salient object at or near a center of the composed image according to the position and size information of the salient object. In some embodiments, the composed image can be output as the corrected image. In some other embodiments, the composed image can be scaled or further cropped to obtain the corrected image, for example, according to an aspect ratio of the screen of the image capture device 201 or a display external to the image capture device 201, such that an aspect ratio of the corrected image can be consistent with the aspect ratio of the screen of the image capture device 201 or the display. Any method suitable for detecting a salient object can be employed, for example, methods based on deep learning (e.g., hierarchical deep networks, multi-scale, multi-context deep learning framework, symmetrical network, or the like), frequency domain analysis, sparse representation, cellular automata, random walks, low-rank recovery, Bayesian theory, or the like.

In some embodiments, a plurality of salient objects can be obtained in the rotated image. A saliency map showing a distribution of salient objects in the image can be calculated according to the position and size information of the plurality of salient objects. The distribution of salient objects may refer to a spatial distribution of salient objects in the image. The image composition circuit 204 can compose the rotated image based on the saliency map and the composition rule. For example, if the composition rule is the symmetric composition rule, then the rotated image can be cropped to cause the distribution of the salient objects to be symmetric or near symmetric in the composed image.

In some other embodiments, the image composition circuit 204 can be configured to compose the rotated image via a network model or a tree structure. In some embodiments, the network model can be obtained by training based on a plurality of samples using an optimization process that requires a loss function to converge to a minimum model error. The loss function can include, but is not limited to, for example, a cross-entropy, a mean squared error, and/or the like. Any method suitable for training the network model can be employed. The plurality of samples can include a plurality of image samples. The image samples can be, for example, obtained by the image capture device 201, downloaded from Internet, obtained from an image library, and/or the like. The rotated image can be inputted to the network model or the tree structure, and be processed according to the network model or the tree structure, to obtain cropping coordinates and/or scaling factors. That is, an input of the network model or the tree structure is the rotated image, and outputs of the network model or the tree structure are the cropping coordinates and/or scaling factors of the rotated image. The rotated image can be cropped, according to the cropping coordinates, to obtain the composed image, and the corrected image can be obtained by scaling the composed image according to the scaling factors.

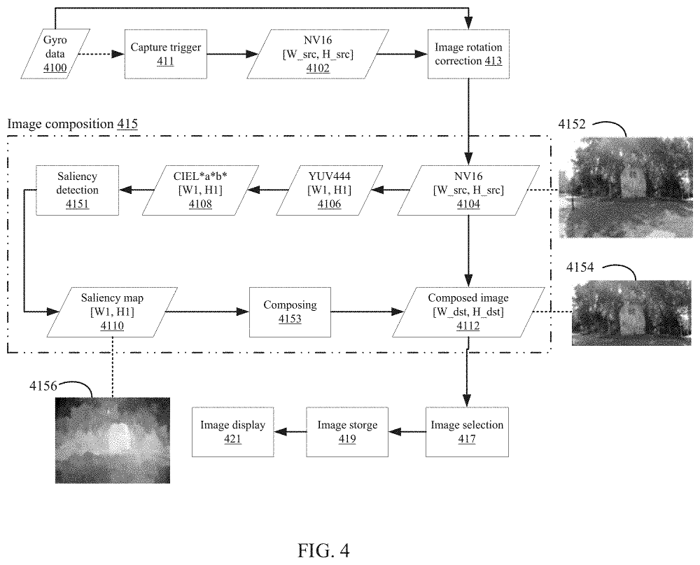

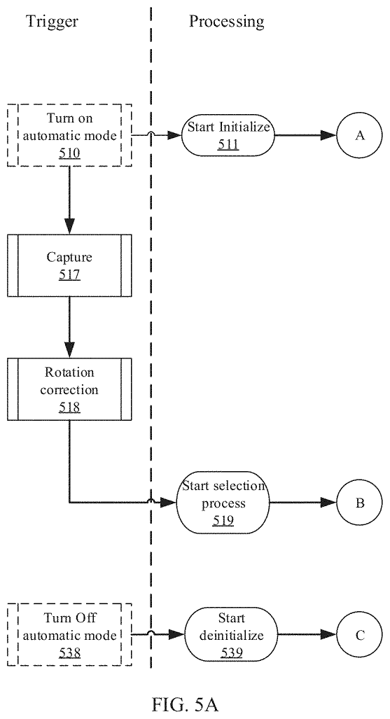

FIG. 4 is a flow chart of an example image processing process that can be implemented by, e.g., the photographing apparatus 200. As shown in FIG. 4, at 411, the photographing operation of the image capture device 201 can be triggered by the capture selection circuit 202 to capture an image 4102 of the current scene using a combination of software and hardware. For example, the captured image 4102 can be an image in NV16 format with a resolution of (W_src, H_src), e.g., (4000, 3000). The NV16 format can be also referred to as YUV 422.

At 413, the rotation correction can be performed on the captured image 4102 by the image rotation correction circuit 203, according to gyro data 4100 obtained by an IMU, to generate a rotated image 4104. As shown in FIG. 4, an image 4152 is an example of the rotated image 4104. The format and resolution of the rotated image 4104 are same as those of the captured image 4102. The gyro data 4100 can be obtained synchronously when the photographing operation is triggered to obtain the captured image 4102. The rotation correction process is similar to the process in FIG. 3, and detailed description thereof is omitted herein.

At 415, the rotated image 4104 is composed by the image composition circuit 204. In some embodiments, a Barycentric Interpolation (also referred as UV interpolation) can be implemented to convert the rotated image 4104 in NV16 format to a rotated image 4106 in YUV444 format. The format YUV 444 generally has four U values and four V values for every four Y samples of the image data, and the format NV16 generally has two U values and two V values for every four Y samples. Thus, two values of U and V per every four Y samples can be converted to four values of U and V per every four Y samples by interpolating U and V into two values of U and V per every four Y samples. In some embodiments, the rotated image 4104 can be scaled before being interpolated. For example, the rotated image 4104 can be scaled to convert the resolution from (W_src, H_src) to (W1, H1), e.g., from (4000, 3000) to (480, 360), to improve a processing efficiency of a saliency detection on the rotated image. As such, the resolution of the rotated image 4106 in YUV444 format is smaller than the resolution of the rotated image 4104 in NV16 format.

In some embodiments, the rotated image 4106 in YUV color space can be further converted to a rotated image 4108 in CIE L*a*b color space. For example, the color space of the rotated image 4106 can be converted from YUV color space to RGB (Red-Green-Blue) color space according to any suitable conversion formulas. In some embodiments, a gamma correction can be performed on the rotated image 4106 in RGB color space to control an overall brightness of the rotated image 4106. A gamma value of the gamma correction can be determined according to the actual requirements. The color space of the rotated image 4106 after gamma correction can be converted from the RGB color space to the CIE L*a*b color space according to any suitable conversion formulas. The conversion formulas can be determined according to, for example, a specification of the image sensor of the image capture device 201 or the like. In some embodiments, a color temperature adjustment can be also performed on the rotated image 4106 after gamma correction or the rotated image 4108.

At 4151, the saliency detection is performed on the rotated image 4108 to obtain a saliency map 4110 of the rotated image 4108. Any suitable saliency detection method can be used to obtain the saliency map 4110. For example, features of the rotated image 4108 can be extracted. The features can include, but is not limited to, colors, intensity, and/or orientations. The colors of each pixel of the rotated image 4108 can be obtained, for example, in the CIE L*a*b color space. The intensity of each pixel of the rotated image 4108 can be obtained, for example, by converting the rotated image 4108 to a grayscale. The orientations of each pixel of the rotated image 4108 can be obtained, for example, using Gabor filters with respect to four angles. All of these processed images mentioned above can be used to create Gaussian pyramids to generate feature maps. The feature maps can be generated with regard to each of the three features, and the saliency map 4110 is a mean of the three feature maps. As shown in FIG. 4, an image 4156 is an example of the saliency map 4110. The position and size information of the salient object (e.g., a house in the image 4152) in the rotated image 4108 can be obtained according to the saliency map 4110.

At 4153, the rotated image 4104 can be composed according to the saliency map 4110 to obtain a composed image 4112. For example, the position and size information of the salient object (e.g., the house in the image 4152) in the rotated image 4104 can be obtained according to the position and size information of the salient object in the rotated image 4108. A central composition rule can be selected, and thus the rotated image 4180 can be cropped to place the salient object (e.g., the house in the image 4152) at a center of the composed image 4112. As such, a resolution of the composed image 4112 is smaller than the resolution of the rotated image 4104. As shown in FIG. 4, an image 4154 having the house in the center of the image is an example of the composed image 4112.

Even though a maximum visible range of human eyes is about 170 degrees, a clear imaging range of human eyes is only about 60 degrees, such that the image having the ultra-wide FOV does not satisfy visual comfort requirements of the human eyes. The human eyes generally focus on a center of the image, such that the scenes at the edge of the image are redundant. Therefore, cropping the rotation image to obtain the composed image is more suitable for visual comfort requirements of the human eyes.

At 417, a selection process is performed on the composed image 4112 by the image selection circuit 205 and detailed description will be described below.

At 419 and 421, the composed image 4112 can be stored and displayed by the image display circuit 206 according to a determination result of the selection process, and detailed description will be described below.

In some embodiments, the image capture device 201 can bypass the image rotation correction circuit 203 and send the captured image to the image composition circuit 204 directly for composition. In some other embodiments, the image rotation correction circuit 203 can be omitted at all. In these embodiments (either the image rotation correction circuit 203 be bypassed or be omitted at all), the image composition circuit 204 can be coupled to the image capture device 201 and can be configured to automatically compose the captured image to obtain the corrected image.

In some embodiments, the image rotation correction circuit 203 can bypass the image composition circuit 204 and send the rotated image to the image selection circuit 205 directly. In some other embodiments, the image composition circuit 204 can be omitted at all. In these embodiments (either the image composition circuit 204 be bypassed or be omitted at all), the rotated image can be regarded as the corrected image, and the image selection circuit 205 can be coupled to the image rotation correction circuit 203.

In some embodiments, the image capture device 201 can bypass the image rotation correction circuit 203 and the image composition circuit 204, and send the captured image to the image selection circuit 205 directly. In some other embodiments, both the image rotation correction circuit 203 and the image composition circuit 204 can be omitted at all. In these embodiments (either the image rotation correction circuit 203 and the image composition circuit 204 be bypassed or omitted at all), the image selection circuit 205 can be coupled to the image capture device 201.

The image selection circuit 205 can include, for example, a microprocessor, a portion of a microprocessor, an ASIC, or a portion of an ASIC, and can be configured to receive the corrected image from the image composition circuit 204 or the image rotation correction circuit 203, and perform the selection process on the corrected image. For example, the image selection circuit 205 can perform the selection process on the corrected image to determine whether to store the corrected image in the memory of the image capture device 201 or display the corrected image on the screen of the image capture device 201 or the display external to the image capture device 201.

In some embodiments, the image selection circuit 205 can determine a score of the corrected image according an aesthetics rule. The score can also be referred to as an aesthetic score. In some embodiments, the aesthetic rule can be determined according to at least one of signal-to-noise ratio (SNR), contrast, histogram distribution, image saturation, information entropy, AE value, AF value, AWB value, or high scoring object of the candidate image, such as people, smiles, sunrise, pets, and/or the like. In some other embodiments, the aesthetic rule can be determined according to a trained model. The trained model can be obtained by training using a dataset of pre-evaluated scores. For example, the pre-evaluated scores can be aesthetic pleasing scores of an image pre-evaluated by different persons. The trained model can be obtained by training using any suitable machine learning algorithms.

In some embodiments, if the score is lower than a preset threshold, the image selection circuit 205 can determine to discard or delete the corrected image. If the score is higher than the preset threshold, the image selection circuit 205 can determine to store the corrected image in a current album, and/or send the corrected image to the image display circuit 206. For example, the current album can be set in the memory of the image capture device 201.

In some other embodiments, the image selection circuit 205 can also extract at least one image feature from the corrected image for determining a similarity between the corrected image and the images in the current album. The at least one image feature can include at least one of histogram, a shift feature, an image moment, or a fingerprint of the image. The fingerprints of an image are perceptual features or short summaries of the image, for example, a perceptual harsh (pHash) or the like. In some embodiments, the image selection circuit 205 can determine one or more similar images in a current album that are similar to the corrected image, according to the extracted at least one image feature. If the score of the corrected image is lower than a lowest score of the one or more similar images, the image selection circuit 205 can determine to discard the corrected image. If the score of the corrected image is higher than the lowest score of the one or more similar images, the image selection circuit 205 can determine to store the corrected image in the current album. In some embodiments, the one or more similar images having scores lower than the score of the corrected image can be deleted from the current album.

In some other embodiments, if the score of the corrected image is lower than a highest score of the one or more similar images, the image selection circuit 205 can determine to discard the corrected image. If the score of the corrected image is higher than the highest score of the one or more similar images, the image selection circuit 205 can determine to store the corrected image in the current album, and the one or more similar images can be deleted from the current album.

The image display circuit 206 can include, for example, a microprocessor, a portion of a microprocessor, an ASIC, or a portion of an ASIC, and can be configured to output the corrected image. In some embodiments, the images in the current album can be arranged in a queue according to the scores of the images. The image display circuit 206 can receive the corrected image from the image selection circuit 205 and insert the corrected image into the queue of the current album according to the score of the corrected image. Herein, the corrected image can also be referred to as a candidate image for the current album.

The image display circuit 206 can be configured to display the queue of the current album on the screen of the image capture device 201. In some embodiments, the queue of the current album can be displayed in order, such that the user can view the images having better aesthetic pleasing scores first. In some other embodiments, the queue of the current album can be displayed in a nine-square grid, such that the user can view the images as a batch.

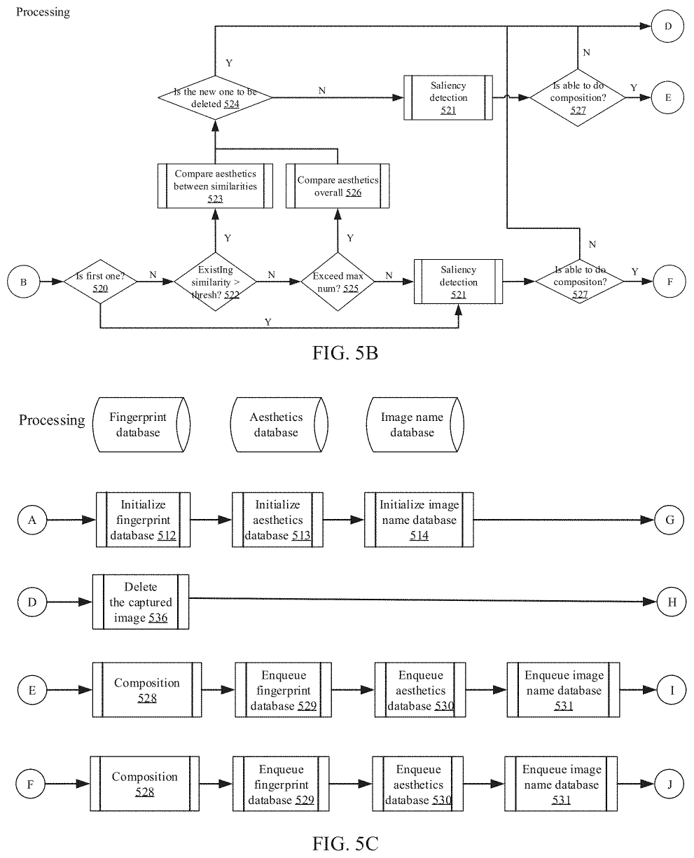

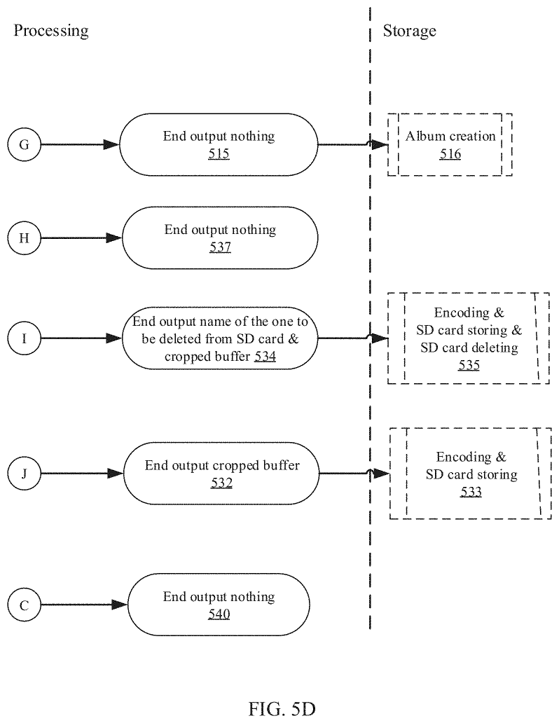

FIGS. 5A to 5D show a flow chart of an example process that can be implemented by, e.g., the photographing apparatus 200. As shown in FIG. 5A, at 510, an automatic mode is turned on. For example, the photographing apparatus 200 can turn on the automatic mode, when receiving an automatic-mode-turn-on command from a user interface (UI). At 511, an initialization process is started. The photographing apparatus 200 can start the initialization after turning on the automatic mode. As shown in FIG. 5C, at 512, an image fingerprint database stored in the photographing apparatus 200 is initialized. At 513, an aesthetics database stored in the photographing apparatus 200 is initialized. At 514, an image name database stored in the photographing apparatus 200 is initialized. The image fingerprint database, the aesthetics database, and the image name database can be stored, for example, in the memory of the image capture device 201. As shown in FIG. 5D, at 515, the initialization process ends. In some embodiments, at 516, a new image album can be created in the memory of the image capture device 201. The new image album can be used as the current album.

Referring again to FIG. 1, at 517, the photographing operation of the image capture device 201 is automatically triggered by the capture selection circuit 202 to capture the image of the current scene using a combination of software and hardware. At 518, the rotation correction is automatically performed on the captured image by the image rotation correction circuit 203. At 519, the selection process is started to perform on the rotated image by the image selection circuit 205.

As shown in FIG. 5B, at 520, whether the rotated image is a first image in the current album is determined. If the rotated image is the first image (520: Yes), then at 521 the saliency detection can be performed on the rotated image by the image composition circuit 204. If the rotated image is not the first image (520: No), then at 522, whether there are one or more similar images in the current album that are similar to the rotated image can be determined. At 522, whether the number of the one or more similar images is more than a predetermined threshold can be determined. If the number of the one or more similar images is more than the predetermined threshold (522: Yes), then at 523, the aesthetics score of the rotated image and the aesthetics scores of the one or more similar images are compared. Further, at 524, whether to delete (or discard) the captured image (i.e., a newest captured image) is determined. If the aesthetics score of the rotated image is higher than the highest aesthetics score or the lowest aesthetics of the one or more similar images, the image selection circuit 205 can determine not to delete the captured image (524: No), and at then 521, the saliency detection can be performed on the rotated image by the image composition circuit 204. If the aesthetics score of the rotated image is less than the highest aesthetics score or the lowest aesthetics of the one or more similar images, the image selection circuit 205 can determine to delete the captured image (524: Yes).

If the number of the one or more similar images is less than the predetermined threshold (522: No), then at 525, whether the number of the images in the current album exceeds a maximum number is determined. If the number of the images in the current album does not exceed the maximum number (525: No), then at 521, the saliency detection can be performed on the rotated image by the image composition circuit 204. If the number of the images in the current album exceeds the maximum number (525: Yes), then at 526, the aesthetics score of the rotated image and the aesthetics scores of all of the images in the current album are compared, and the comparison results can be used at 524 to determine whether to delete the captured image. For example, if the aesthetics score of the rotated image is less than the lowest aesthetics of the images in the current album, the image selection circuit 205 can determine to delete the captured image (524: Yes). If the aesthetics score of the rotated image is higher than the lowest aesthetics of the images in the current album, the image selection circuit 205 can determine not to delete the captured image (524: No), and then at 521, the saliency detection can be performed on the rotated image by the image composition circuit 204.

At 527, whether the rotated image is able to be composed is determined. In some embodiments, whether the rotated image is able to be composed can be determined according to the saliency map. For example, if a distribution of the saliency map is too scattered, the image composition circuit 204 can determine the rotated image cannot be composed. As another example, if there is not saliency object detected in the rotated image, the image composition circuit 204 can determine the rotated image cannot be composed. If the rotated image is determined as being able to be composed (527: Yes), then at 528 (shown in FIG. 5C), the rotated image is composed by the image composition circuit 204 to obtain the corrected image.

As shown in FIG. 5C, at 529, the fingerprints of the corrected image are enqueued into the fingerprint database. The fingerprints of the corrected image can be extracted from the corrected image, and the fingerprints of the corrected image can be added into a queue of the fingerprint database. At 530, the aesthetics score of the corrected image is enqueued into the aesthetics database. The aesthetics score of the corrected image can be added into a queue of the aesthetics database. For example, the queue of the aesthetics database can be arranged according to an order of the aesthetics scores. At 531, an image name of the corrected image is enqueued into a queue of the image name database. The image name of the corrected image can include, but is not limited to, a number, a letter, a word, or the like. In some embodiments, the queue of fingerprint database and the queue of the image name database can be arranged in the same order as the queue of the aesthetics, which is convenient for the data retrieval.

If the captured image is the first image (520: Yes), or the number of the one or more similar images is less than the predetermined threshold (522: No) and the number of the images in the current album does not exceed the maximum number (525: No), then at 532 (shown in FIG. 5D), the corrected image is outputted and a buffer in the memory for temporary storing the corrected image can be cropped. In some embodiments, as shown in FIG. 5D, at 533, the outputted corrected image is stored in the memory of the image capture device 201, for example, a secure digital (SD) card. In some embodiments, at 533, the corrected image is also encoded before or after storing.

If the captured image is not the first image (520: No), and the number of the one or more similar images is more than the predetermined threshold (522: Yes) or the number of the one or more similar images is not more than the predetermined threshold (522: No) but the number of the images in the current album exceeds the maximum number (525: Yes), then at 534 (as shown in FIG. 5D), the corrected image is stored in the memory of the image capture device 201. In some embodiments, at 534, the corrected image is outputted, the names of the one or more similar images having scores lower than the score of the corrected image are outputted, and the buffer in the memory for temporary storing the corrected image can be cropped. As shown in FIG. 5D, in some embodiments, at 535, the outputted corrected image is stored in the memory of the image capture device 201, for example, the secure digital (SD) card. In some embodiments, at 535, the corrected image is also encoded before or after storing. In some embodiments, at 535, the one or more similar images having scores lower than the score of the corrected image are deleted from the memory of the image capture device 201.

If the captured image is determined to be deleted (524: Yes) or is determined as not being able to compose (527: No), then delete the captured image (536). As shown in FIG. 5D, at 537, the process ends.

Referring again to FIG. 5A, at 538, the automatic mode is turned off. For example, the photographing apparatus 200 can turn off the automatic mode, when receiving an automatic-mode-turn-off command from the UI. A deinitialization process is started (539). For example, the deinitialization process can be performed on the fingerprint database, the aesthetics database, and the image name database. The deinitialization process is an inverse process of the initialization process. As shown in FIG. 5D, at 540, the deinitialization process ends.

Consistent with the disclosure, the user can wear the photographing apparatus 200 or arrange the photographing apparatus 200 at a fixed location, and the images can be automatically shot during working time of the photographing apparatus 200 without requiring any participation of the user. The captured images can be automatically rotated to ensure zero tilt at any angle of the images, and the rotated images can be automatically composed according to the content of the scene, such that the images having a better FOV and a reasonable layout can be obtained. Furthermore, the distortion effects can be weakened by automatically performing distortion correction. Also, the image having pleasing aesthetic can be obtained. In addition, a lot of duplicated or similar images and meaningless shots can be deleted by automatically selecting the images, such that the user can end up with only a certain number of images having better quality and view the images in a friendly visual manner.

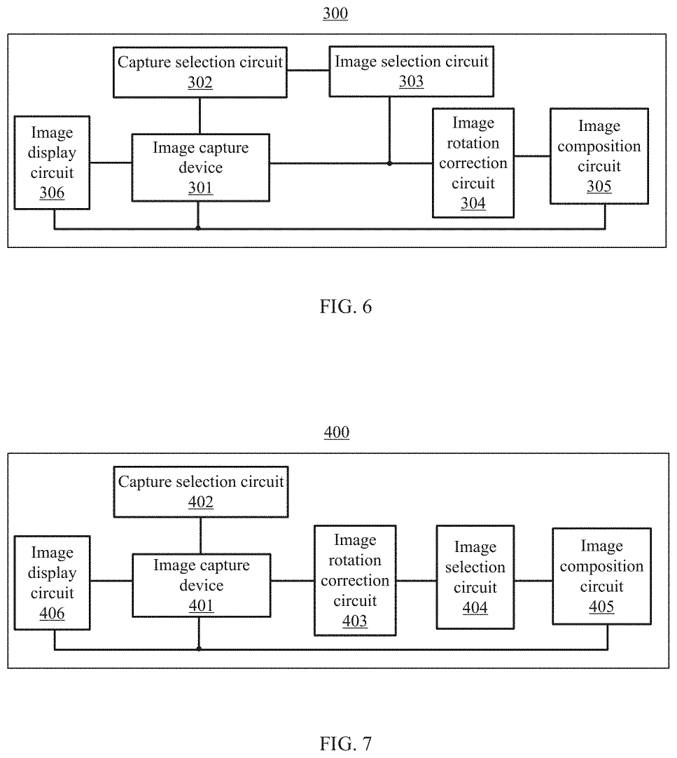

FIG. 6 is a schematic diagram of another example photographing apparatus 300 consistent with the disclosure. As shown in FIG. 6, the photographing apparatus 300 includes a image capture device 301, a capture selection circuit 302 coupled to the image capture device 301, an image selection circuit 303 coupled to the image capture device 301 and the capture selection circuit 302, an image rotation correction circuit 304 coupled to the image capture device 301, an image composition circuit 305 coupled to the image rotation correction circuit 304 and the image capture device 301, and an image display circuit 306 coupled to the image composition circuit 305 and the image capture device 301. The image capture device 301 is similar to the image capture device 201, and detailed description thereof is omitted herein.

The image selection circuit 303 can include, for example, a microprocessor, a portion of a microprocessor, an ASIC, or a portion of an ASIC, and can be configured to perform the selection process on the live-view image in the live view of the image capture device 301 in a real time manner. For example, the image selection circuit 303 can perform the selection process on the live-view image in the live view to determine whether to capture the live-view image. The live-view image refers to an image of the current scene in the live view of the image capture device 301. Herein, the live-view image and the current scene can be used interchangeably.

In some embodiments, the image selection circuit 303 can score the live-view image in the live view in real-time based on the aesthetics rule to determine a score of the live-view image. The methods for determining the aesthetic rule are similar to the methods used by the image selection circuit 205, and detailed description thereof is omitted herein. In some embodiments, if the score is lower than the preset threshold, the image selection circuit 303 can determine to not capture the live-view image in the live view of the image capture device 301. If the score is higher than the preset threshold, the image selection circuit 303 can determine to capture the live-view image in the live view of the image capture device 301.

In some other embodiments, the image selection circuit 303 can also extract at least one image feature from the live-view image for determining a similarity between the live-view image and the images in the current album of the image capture device 301. The at least one image feature can include at least one of the histogram, the shift feature, the image moment, or the fingerprint of the image. If the score of the live-view image is lower than the lowest score of the one or more similar images that are similar to the live-view image, the image selection circuit 303 can determine to not capture the live-view image. If the score of the live-view image is higher than the lowest score of the one or more similar images, the image selection circuit 303 can determine to capture the live-view image. In some embodiments, the one or more similar images having scores lower than the score of the live-view image can be deleted from the current album.

In some other embodiments, if the score of the live-view image is lower than the highest score of the one or more similar images, the image selection circuit 303 can determine to not capture the live-view image. If the score of the live-view image is higher than the highest score of the one or more similar images, the image selection circuit 303 can determine to capture the live-view image in the live view, and the one or more similar images can be deleted from the current album.

In some embodiments, the image selection circuit 303 can send a determination result indicating if the score of the live-view image is higher than the threshold to the capture selection circuit 302, and the capture selection circuit 302 can automatically trigger the photographing operation of the image capture device 301 according to the determination result of the image selection circuit 303. In some embodiments, the image selection circuit 303 can bypass the capture selection circuit 302. In some other embodiments, the capture selection circuit 302 can be omitted at all. In these embodiments (either the capture selection circuit 302 be bypassed or be omitted), the image selection circuit 303 can be coupled to the image capture device 301 and directly trigger the photographing operation of the image capture device 301 according to the determination result of the image selection circuit 303.

The capture selection circuit 302 include, for example, a microprocessor, a portion of a microprocessor, an ASIC, or a portion of an ASIC, and can be configured to automatically trigger the photographing operation of the image capture device 301 to capture the live-view image in the live view. In some embodiments, the capture selection circuit 302 can trigger the photographing operation according to a combination of the score of the live-view image and one or more other criteria. In some embodiments, the capture selection circuit 302 can trigger the photographing operation when the object with the specific semantic is detected in the current scene and the score of the live-view image is higher than the threshold. The specific semantic can include, but is not limited to, e.g., people, animal, face, or smile. In some embodiments, the capture selection circuit 302 can trigger the photographing operation when the change of the depth of the current scene is detected and the score of the live-view image is higher than the threshold. In some embodiments, the capture selection circuit 302 can trigger the photographing operation when the change of the focus of the current scene is detected and the score of the live-view image is higher than the threshold. In some embodiments, the capture selection circuit 302 can trigger the photographing operation when the voice command is received and the score of the live-view image is higher than the threshold. In some embodiments, the capture selection circuit 302 can trigger the photographing operation based on a combination of the control process and the score of the live-view image. The control process can include the timer photographing, the time-lapse photographing, or the like. For example, the capture selection circuit 302 can trigger the photographing operation at the preset time using the timer photographing, if the score of the live-view image at the preset time is higher than the threshold. As another example, the capture selection circuit 202 can trigger the photographing operation at a preset time period using time-lapse photographing, if the score of the live-view image at the preset time period is higher than the threshold.

The image rotation correction circuit 304 can include, for example, a microprocessor, a portion of a microprocessor, an ASIC, or a portion of an ASIC, and can be configured to receive the captured image from the image capture device 301 and automatically perform the rotation correction on the captured image. The image rotation correction circuit 304 is similar to the image rotation correction circuit 203, and detailed description thereof is omitted herein.

The image composition circuit 305 can include, for example, a microprocessor, a portion of a microprocessor, an ASIC, or a portion of an ASIC, and can be configured to receive the rotated image from the image rotation correction circuit 203, automatically compose the rotated image to generate the correct image. The methods for composing the rotated image is similar to the methods used by the image composition circuit 204, and detailed description thereof is omitted herein.

In some embodiments, the image composition circuit 305 can be also configured to perform the selection process on the rotated image before composing the rotated image. In some embodiments, the image composition circuit 305 can perform the selection process based on the saliency detection. For example, if no salient object is detected in the rotated image, the image composition circuit 305 can discard the rotated image. If at least one salient object is detected in the rotated image, the image composition circuit 305 can compose the rotated image based on the position and size information of the at least one salient object in the rotated image. As another example, when the plurality of salient objects are detected in the rotated image, but the distribution of salient objects in the image is not pleasing, the image composition circuit 305 can discard the rotated image, otherwise, the image composition circuit 305 can compose the rotated image based on the distribution of the plurality of salient objects in the rotated image. For example, whether the distribution of salient objects in the image is pleasing can be determined, according to the distribution's tendency to be concentrated or dispersed, which is not limited herein.

In some embodiments, the image capture device 301 can bypass the image rotation correction circuit 304 and the image composition circuit 305. In some other embodiment, the image rotation correction circuit 304 and the image composition circuit 305 can be omitted at all. In these embodiments (either the image rotation correction circuit 304 and the image composition circuit 305 be bypassed or be omitted), the image display circuit 306 can be coupled to the image capture device 301 and can be configured to directly store the captured image in the current album of the image capture device 301.

In some embodiments, the image capture device 301 can bypass the image rotation correction circuit 304, and send the captured image to the image composition circuit 305 directly. In some other embodiments, the image rotation correction circuit 304 can be omitted. In these embodiments (either the image rotation correction circuit 304 be bypassed or be omitted), the image composition circuit 305 can be coupled to the image capture device 301 and can be configured to automatically compose the captured image to obtain the corrected image.

In some embodiments, the image rotation correction circuit 304 can bypass the image composition circuit 305, and send the rotated image to the image display circuit 306 directly. In some other embodiments, the image composition circuit 305 can be omitted at all. In these embodiments (either the image composition circuit 305 be bypassed or be omitted), the rotated image can be regarded as the corrected image, and the image display circuit 306 can directly store the rotated image in the current album of the image capture device 301.

In some embodiments, the photographing apparatus 300 may further includes the image distortion correction circuit (not shown in FIG. 6) coupled to the image rotation correction circuit 304 and/or the image capture device 301. The image distortion correction circuit can include, for example, a microprocessor, a portion of a microprocessor, an ASIC, or a portion of an ASIC, and can be configured to perform the distortion correction before or after rotating the captured image. The method for the distortion correction can be chosen according to the type of the distortion, and any suitable method can be employed.

In some embodiments, the photographing apparatus 300 may include the image correction circuit instead of the image distortion correction circuit and the image rotation correction circuit 304. The image correction circuit can be configured to perform both the distortion correction and the rotation correction on the captured image.

The image display circuit 306 can include, for example, a microprocessor, a portion of a microprocessor, an ASIC, or a portion of an ASIC, and can be configured to output the corrected image. For example, the image display circuit 306 can receive the corrected image from the image selection circuit 305 and insert the corrected image into the queue of the current album according to the score of the corrected image, and display the queue of the current album in the nine-square grid. The image display circuit 306 is similar to the image display circuit 206, and detailed description thereof is omitted herein.

Consistent with the disclosure, the images having pleasing aesthetic can be automatically triggered to shot during working time of the photographing apparatus 200 without requiring any participation of the user. The captured images can be automatically rotated and composed, such that the images having the better FOV and the reasonable layout can be obtained. In addition, a lot of duplicated or similar images and meaningless shots can be deleted by automatically selecting the images, such that the user can end up with only a certain number of images having better quality and view the images in the friendly visual manner.

FIG. 7 is a schematic diagram of another example photographing apparatus 400 consistent with the disclosure. As shown in FIG. 7, the photographing apparatus 400 includes a image capture device 401, a capture selection circuit 402 coupled to the image capture device 401, an image rotation correction circuit 403 coupled to the image capture device 401, an image selection circuit 404 coupled to the image rotation correction circuit 403, an image composition circuit 405 coupled to the image selection circuit 404 and the image capture device 401, and an image display circuit 406 coupled to the image composition circuit 405 and the image capture device 401.

The image capture device 401 is similar to the image capture device 201, and detailed description thereof is omitted herein. The capture selection circuit 402 can include, for example, a microprocessor, a portion of a microprocessor, an ASIC, or a portion of an ASIC, and can be configured to automatically trigger the photographing operation of the image capture device 401 to capture the image of the current scene using a combination of software and hardware. The capture selection circuit 402 is similar to the capture selection circuit 202, and detailed description thereof is omitted herein. The image rotation correction circuit 403 can include, for example, a microprocessor, a portion of a microprocessor, an ASIC, or a portion of an ASIC, and can be configured to receive the captured image from the image capture device 401 and automatically perform the rotation correction on the captured image. The image rotation correction circuit 403 is similar to the image rotation correction circuit 203, and detailed description thereof is omitted herein.

The image selection circuit 404 can include, for example, a microprocessor, a portion of a microprocessor, an ASIC, or a portion of an ASIC, and can be configured to receive the rotated image from the image rotation correction circuit 203 and perform the selection process on the rotated image. In some embodiments, the image selection circuit 404 can determine a score of the rotated image according to the aesthetics rule. The methods for determining the aesthetic rule are similar to the methods used by the image selection circuit 205, and detailed description thereof is omitted herein. In some embodiments, if the score is lower than the preset threshold, the image selection circuit 404 can determine to discard the rotated image. If the score is higher than the preset threshold, the image selection circuit 404 can determine to send the rotated image to the image composition circuit 405 for composition.

In some other embodiments, the image selection circuit 404 can also extract at least one image feature from the rotated image for determining a similarity between the rotated image and the images in the current album of the image capture device 401. The at least one image feature can include at least one of the histogram, the shift feature, the image moment, or the fingerprint of the image. If the score of the rotated image is lower than the lowest score of the one or more similar images that are similar to the rotated image, the image selection circuit 404 can determine to discard the rotated image. If the score of the rotated image is higher than the lowest score of the one or more similar images, the image selection circuit 404 can determine to send the rotated image to the image composition circuit 405 for composition. In some embodiments, the one or more similar images having scores lower than the score of the rotated image can be deleted from the current album.

In some other embodiments, if the score of the rotated image is lower than the highest score of the one or more similar images, the image selection circuit 404 can determine to discard the rotated image. If the score of the live-view image is higher than the highest score of the one or more similar images, the image selection circuit 404 can determine to send the rotated image to the image composition circuit 405 for composition, and the one or more similar images can be deleted from the current album.

The image composition circuit 405 can include, for example, a microprocessor, a portion of a microprocessor, an ASIC, or a portion of an ASIC, and can be configured to automatically compose the rotated image to generate the correct image. The methods for composing the rotated image is similar to the methods used by the image composition circuit 204, and detailed description thereof is omitted herein.

In some embodiments, considering that the rotated image may have no similar image in the current album, but the corrected image after compositing the rotated image may have one or more similar images in the current album, a similarity determination can be also performed by the image composition circuit 405. For example, the image composition circuit 405 can be configured to extract the at least one image feature from the corrected image for determining the similarity between the corrected image and the images in the current album of the image capture device 401. The selection process via the similarity determination is similar to the selection process used by the image selection circuit 205, and detailed description thereof is omitted herein.

In some embodiments, the image capture device 401 can bypass the image rotation correction circuit 403 and send the captured image to the image selection circuit 404 directly. In some other embodiments, the image rotation correction circuit 403 can be omitted at all. In these embodiments (either the image rotation correction circuit 403 be bypassed or omitted at all), the image selection circuit 404 can be coupled to the image capture device 401.

In some embodiments, the image selection circuit 404 can bypass the image composition circuit 405 and send the rotated image to the image display circuit 406. In some other embodiments, the image composition circuit 405 can be omitted at all. In these embodiments (either the image composition circuit 405 be bypassed or omitted at all), the image selection circuit 404 can coupled to the image display circuit 406.

In some embodiments, the photographing apparatus 400 may further includes the image distortion correction circuit (not shown in FIG. 7) couple to the image rotation correction circuit 403 and/or the image capture device 401. The image distortion correction circuit can include, for example, a microprocessor, a portion of a microprocessor, an ASIC, or a portion of an ASIC, and can be configured to perform the distortion correction before or after rotating the captured image. The method for the distortion correction can be chosen according to the type of the distortion, and any suitable method can be employed.

In some embodiments, the photographing apparatus 400 may include the image correction circuit instead of the image distortion correction circuit and the image rotation correction circuit 403. The image correction circuit can be configured to perform both the distortion correction and the rotation correction on the captured image.

The image display circuit 406 can be configured to output the corrected image. For example, the image display circuit 406 can receive the corrected image from the image composition circuit 405 or the image selection circuit 404, and insert the corrected image into the queue of the current album according to the score of the corrected image, and display the queue of the current album in the nine-square grid. The image display circuit 406 is similar to the image display circuit 206, and detailed description thereof is omitted herein.

Therefore, as shown in FIGS. 2 to 4, the photographing apparatus can perform the selection process by the image selection circuit before storing the images, before capturing the live-view images, or before composing the rotated images, as long as the album of the camera are guaranteed to have no duplicate images, and the stored images in the album can have high aesthetic value to satisfy the user interest.

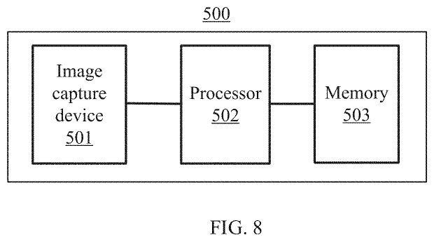

FIG. 8 is a schematic diagram of another example photographing apparatus 500 consistent with the disclosure. As shown in FIG. 8, the photographing apparatus 500 includes a image capture device 501, a processor 502 coupled to the image capture device 501, and a memory 503 coupled to the processor 502. The image capture device 501 is similar to the image capture device 201, and detailed description thereof is omitted herein. The processor 502 and the memory 503 can together form an image processing device consistent with the disclosure.

The processor 502 may be any suitable hardware processor, such as an image processor, an image processing engine, an image-processing chip, a graphics-processor (GPU), a microprocessor, a micro-controller, a central processing unit (CPU), a network processor (NP), a digital signal processor (DSP), an application specific integrated circuit (ASIC), a field-programmable gate array (FPGA), or another programmable logic device, discrete gate or transistor logic device, discrete hardware component. The memory 503 may include a non-transitory computer-readable storage medium, such as a random access memory (RAM), a read only memory, a flash memory, a volatile memory, a hard disk storage, or an optical media. The memory 503 may store computer program instructions, the images captured by the image capture device 501, the images processed by the processor 502, and/or the like.

In some embodiments, the processor 502 can be configured to execute the computer program instructions stored in the memory 503 to realize the functions of the capture selection circuit 202, the image rotation correction circuit 203, the image composition circuit 204, the image selection circuit 205, and/or the image display circuit 206 of the photographing apparatus 200, or to realize the functions of the capture selection circuit 302, the image selection circuit 303, the image rotation correction circuit 304, the image composition circuit 305, and/or the image display circuit 306 of the photographing apparatus 300, or to realize the functions of the capture selection circuit 402, the image rotation correction circuit 403, the image selection circuit 404, the image composition circuit 405, and/or the image display circuit 406 of the photographing apparatus 400.

In some embodiments, the processor 502 can be configured to execute the computer program instructions stored in the memory 503, to perform a photographing method consistent with the disclosure, such as one of the example photographing methods described below.

For example, the processor 502 can be configured to execute the computer program instructions to trigger the photographing operation of the image capture device 501 to capture the image using a combination of software and hardware, correct the captured image to generate the corrected image, and output the corrected image.

As another example, the processor 502 can be configured to execute the computer program instructions to trigger the photographing operation of the image capture device 501 to capture the image of the current scene using a combination of software and hardware, perform the rotation correction on the captured image, compose the rotated image to generate the corrected image, perform the selection process on the corrected image, and output the corrected image.

As another example, the processor 502 can be configured to execute the computer program instructions to trigger the photographing operation of the image capture device 501 to capture the image of the current scene using a combination of software and hardware, perform the selection process on the captured image, and output the captured image.

As another example, the processor 502 can be configured to execute the computer program instructions to trigger the photographing operation of the image capture device 501 to capture the image of the current scene using a combination of software and hardware, perform the rotation correction on the captured image, perform the selection process on the rotated image, and output the rotated image.

As another example, the processor 502 can be configured to execute the computer program instructions to trigger the photographing operation of the image capture device 501 to capture the image of the current scene using a combination of software and hardware, compose the captured image to generate the corrected image, perform the selection process on the corrected image, and output the corrected image.

As another example, the processor 502 can be configured to execute the computer program instructions to perform the selection process on the live-view image in the live view of the image capture device 501 in a real time manner, trigger the photographing operation of the image capture device 501 to capture the live-view image in the live view according to the score of the live-view image, perform the rotation correction on the captured image, compose the rotated image to generate the corrected image, and output the corrected image.

As another example, the processor 502 can be configured to execute the computer program instructions to perform the selection process on the live-view image in the live view of the image capture device 501 in a real time manner, trigger the photographing operation of the image capture device 501 to capture the live-view image in the live view according to the score of the live-view image, compose the captured image to generate the corrected image, and output the corrected image.

As another example, the processor 502 can be configured to execute the computer program instructions to perform the selection process on the live-view image in the live view of the image capture device 501 in a real time manner, trigger the photographing operation of the image capture device 501 to capture the live-view image in the live view according to the score of the live-view image, perform the rotation correction on the captured image, and output the rotated image.

For example, the processor 502 can be configured to execute the computer program instructions to perform the selection process on the live-view image in the live view of the image capture device 501 in a real time manner, trigger the photographing operation of the image capture device 501 to capture the live-view image in the live view according to the score of the live-view image, and output the captured image.

As another example, the processor 502 can be configured to execute the computer program instructions to trigger the photographing operation of the image capture device 501 to capture the image of the current scene using a combination of software and hardware, perform the rotation correction on the captured image, perform the selection process on the rotated image, compose the rotated image to generate the corrected image, and output the corrected image.

In some embodiments, the processor 502 and the memory 503 can be integrated in the image capture device 501. That is, the processor 502 can be the image processing chip of the image capture device 501, and the memory 503 can be the memory of the image capture device 501.

Example photographing methods consistent with the disclosure will be described in more detail below. A photographing method consistent with the disclosure can be implemented in a photographing apparatus consistent with the disclosure, such as the photographing apparatus 200, the photographing apparatus 300, the photographing apparatus 400, or the photographing apparatus 500 described above.

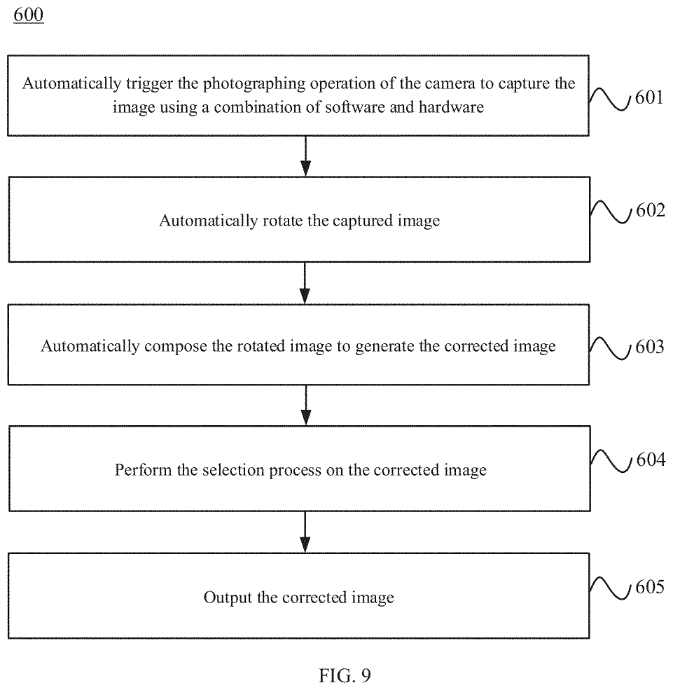

FIG. 9 is a flow chart of an example photographing method 600 consistent with the disclosure. The photographing method 600 can be implemented in the photographing apparatus 200 or the photographing apparatus 500 described above.

As shown in FIG. 9, at 601, the photographing operation of the camera is automatically triggered to capture the image using a combination of software and hardware. In some embodiments, the photographing operation of the camera can be triggered once the object with the specific semantic is detected in the current scene. The specific semantic can include, but is not limited to, e.g., people, animal, face, or smile. In some embodiments, the photographing operation of the camera can be triggered in response to the change of the depth of the current scene. In some embodiments, the photographing operation of the camera can be triggered in response to the change of the focus of the current scene. In some embodiments, the photographing operation of the camera can be triggered through the voice command. In some embodiments, the photographing operation of the camera can be triggered through the control process. The control process can include the timer photographing, the time-lapse photographing, or the like. In some embodiments, the photographing operation of the camera can be triggered according to any combination of different criteria described above.

The process at 601 can be implemented in the capture selection circuit 202 of the photographing apparatus 200 or the processor 502 of the photographing apparatus 500 described above, and detailed description thereof is omitted herein.

At 602, the captured image is automatically rotated. In some embodiments, the attitude information of the camera can be obtained, for example, through one or more attitude sensors mounted at or coupled to the camera, such as an IMU. The attitude information can include at least one of the yaw axis information, the pitch axis information, or the roll axis information of the camera. The captured image can be rotated, according to the attitude information of the camera. For example, the captured image can be rotated, according to the difference between the attitude information of the camera and the target attitude. In some other embodiments, the horizontal line or the vertical line in the captured image can be detected to obtain the tilt angle in the roll direction. The captured image can be rotated in the roll direction, according to the tilt angle, when the tilt angle is smaller than the threshold.

In some embodiments, the distortion correction can be performed before or after rotating the captured image.

The process at 602 can be implemented in the image rotation correction circuit 203 of the photographing apparatus 200 or the processor 502 of the photographing apparatus 500 described above, and detailed description thereof is omitted herein.

At 603, the rotated image is automatically composed to generate the corrected image. In some embodiments, the rotated image can be composed base on the saliency detection and the composition rule. The one or more salient objects can be detected in the captured image. The position and size information of the one or more salient objects or the distribution of the one or more salient objects in the rotated image can be obtained. The rotated image can be cropped to obtain the composed image, according to the position and size information or the distribution of the one or more salient objects in the rotated image and the composition rule. The composition rule can include, but is not limited to, the central composition rule, the triad composition rule, the horizontal line composition rule, the symmetric composition rule, the diagonal composition rule, or the like. The composed image can be scaled or further cropped to obtain the corrected image, for example, according to the aspect ratio of a screen of the camera or a display external to the camera.

In some other embodiments, the rotated image can be composed via the network model or the tree structure. The network model can be obtained by training based on the plurality of samples. The rotated image can be inputted to the network model or the tree structure. The rotated image can be processed according to the network model or the tree structure, to obtain the cropping coordinates and the scaling factors. The rotated image can be cropped to obtain the composed image according to the cropping coordinates, and the composed image can be scaled to obtain the corrected image according to the scaling factors.

The process at 603 can be implemented in the image composition circuit 204 of the photographing apparatus 200 or the processor 502 of the photographing apparatus 500 described above, and detailed description thereof is omitted herein.

At 604, the selection process can be performed on the corrected image. The selection process can be configured to determine whether to store or display the corrected image. In some embodiments, the score of the corrected image can be determined according to the aesthetics rule. If the score is lower than the preset threshold, the corrected image can be discarded and if the score is higher than the preset threshold, the corrected image can be stored. In some embodiments, the aesthetic rule can be determined according to at least one of signal-to-noise ratio (SNR), contrast, histogram distribution, image saturation, information entropy, AE value, AF value, AWB value, or high scoring object of the candidate image, such as people, smiles, sunrise, pets, and/or the like. In some other embodiments, the aesthetic rule can be determined according to the trained model. The trained model can be obtained by training using a dataset of pre-evaluated scores.

In some embodiments, the one or more similar images can be determined in the current album that are similar to the corrected image, according to the at least one image feature. In some embodiments, if the score of the corrected image is lower than the lowest score of the one or more similar images, the corrected image can be discarded. If the score of the corrected image is higher than the lowest score of the one or more similar images, the corrected image can be stored. In some embodiments, the one or more similar images having scores lower than the score of the corrected image can be deleted from the current album. In some other embodiments, if the score of the corrected image is lower than the highest score of the one or more similar images, the corrected image can be discarded. If the score of the corrected image is higher than the highest score of the one or more similar images, the corrected image can be stored. In some embodiments, the one or more similar images can be deleted from the current album.

The process at 604 can be implemented in the image selection circuit 205 of the photographing apparatus 200 or the processor 502 of the photographing apparatus 500 described above, and detailed description thereof is omitted herein.

At 605, the corrected image is outputted. In some embodiments, the corrected image can be inserted into the queue of the current album, according to the score of the corrected image. The queue of the current album can be displayed in order or in the nine-square grid.

The process at 605 can be implemented in the image display circuit 206 of the photographing apparatus 200 or the processor 502 of the photographing apparatus 500 described above, and detailed description thereof is omitted herein.

In some embodiments, the processes at 602 and/or 603 can be omitted. For example, when the process at 602 is omitted, the captured image can be composed directly. As another example, when the process at 603 is omitted, the selection process can be performed on the rotated image directly. As additional example, when the processes at 602 and 603 are omitted, the selection process can be performed on the captured image directly.

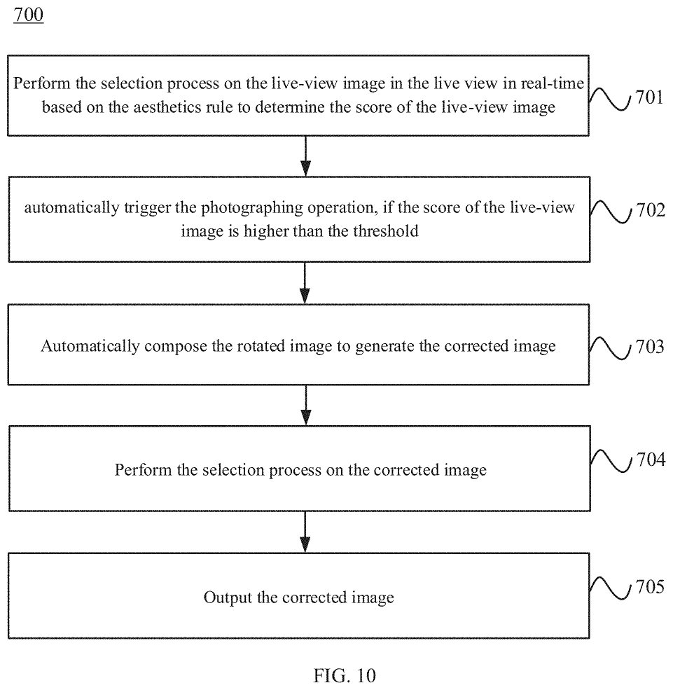

FIG. 10 is a flow chart of another example photographing method 700 consistent with the disclosure. The photographing method 700 can be implemented in the photographing apparatus 300 or the photographing apparatus 500 described above.

As shown in FIG. 10, at 701, the selection process is performed on the live-view image in the live view in real-time based on the aesthetics rule to determine the score of the live-view image. The aesthetic rule can be determined according to at least one of signal-to-noise ratio (SNR), contrast, histogram distribution, image saturation, information entropy, auto-exposure value, auto-focus value, auto-white balance value, or high scoring object of the live-view image.

At 702, the photographing operation is automatically triggered, if the score of the live-view image is higher than the threshold. For example, if the score is lower than the preset threshold, the photographing operation is not triggered to capture the live-view image. If the score is higher than the preset threshold, the photographing operation can be automatically triggered to capture the live-view image. In some embodiments, at least one image feature can be further extracted from the live-view image for determining the similarity between the live-view image and the images in the current album of the camera. The photographing operation can be automatically triggered, if the score of the live-view image is higher than the lowest score or the highest score of the one or more similar images that are similar to the live-view image in the current album.

The process at 701 and 702 can be implemented in the image selection circuit 303 of the photographing apparatus 300 or the processor 502 of the photographing apparatus 500 described above, and detailed description thereof is omitted herein.

At 703, the captured image is automatically rotated. In some embodiments, the attitude information of the camera can be obtained, for example, through one or more attitude sensors mounted at or coupled to the camera, such as an IMU. The attitude information can include at least one of the yaw axis information, the pitch axis information, or the roll axis information of the camera. The captured image can be rotated, according to the attitude information of the camera. For example, the captured image can be rotated, according to the difference between the attitude information of the camera and the target attitude, such that the attitude of the rotated image can be adjusted to the target attitude. In some other embodiments, the horizontal line or the vertical line in the captured image can be detected to obtain the tilt angle in the roll direction. The captured image can be rotated in the roll direction, according to the tilt angle, when the tilt angle is smaller than the threshold.

In some embodiments, the distortion correction can be performed before or after rotating the captured image.

The process at 703 can be implemented in the image rotation correction circuit 304 of the photographing apparatus 300 or the processor 502 of the photographing apparatus 500 described above, and detailed description thereof is omitted herein.

At 704, the rotated image is automatically composed to generate the corrected image. In some embodiments, the rotated image can be composed base on the saliency detection and the composition rule. The one or more salient objects can be detected in the captured image. The position and size information of the one or more salient objects or the distribution of the one or more salient objects in the rotated image can be obtained. The rotated image can be cropped to obtain the composed image, according to the position and size information or the distribution of the one or more salient objects in the rotated image and the composition rule. The composition rule can include, but is not limited to, the central composition rule, the triad composition rule, the horizontal line composition rule, the symmetric composition rule, the diagonal composition rule, or the like. The composed image can be scaled or further cropped to obtain the corrected image, for example, according to the aspect ratio of a screen of the camera or a display external to the camera.

In some other embodiments, the rotated image can be composed via the network model or the tree structure. The network model can be obtained by training based on the plurality of samples. The rotated image can be inputted to the network model or the tree structure. The rotated image can be processed according to the network model or the tree structure, to obtain the cropping coordinates and the scaling factors. The rotated image can be cropped to obtain the composed image according to the cropping coordinates, and the composed image can be scaled to obtain the corrected image according to the scaling factors.

The process at 704 can be implemented in the image composition circuit 305 of the photographing apparatus 300 or the processor 502 of the photographing apparatus 500 described above, and detailed description thereof is omitted herein.

At 705, the corrected image is outputted. In some embodiments, the corrected image can be inserted into the queue of the current album, according to the score of the corrected image. The queue of the current album can be displayed in order or in the nine-square grid.

The process at 705 can be implemented in the image display circuit 306 of the photographing apparatus 300 or the processor 502 of the photographing apparatus 500 described above, and detailed description thereof is omitted herein.

In some embodiments, the processes at 703 and/or 704 can be omitted. For example, when the process at 703 is omitted, the captured image can be composed directly. As another example, when the process at 704 is omitted, the rotated image can be outputted directly. As additional example, when the processes at 703 and 704 are omitted, the captured image can be outputted directly.

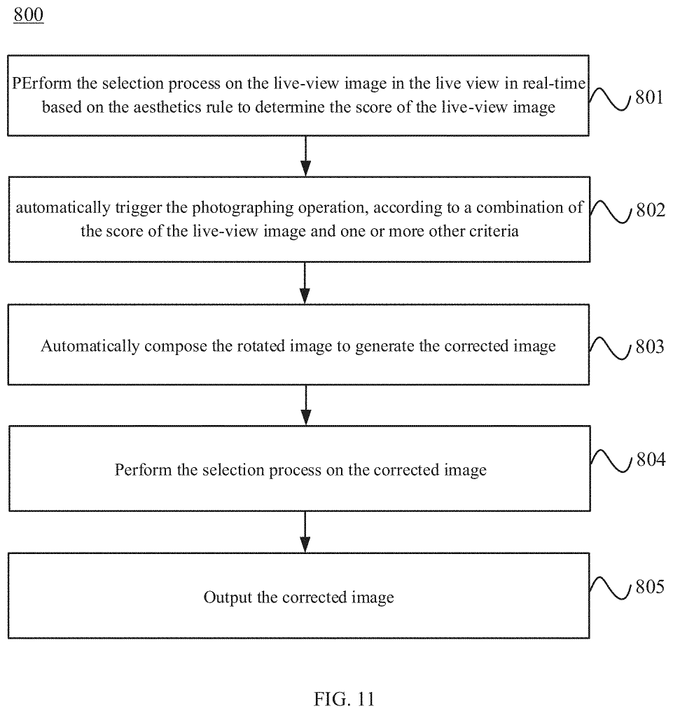

FIG. 11 is a flow chart of another example photographing method 800 consistent with the disclosure. The photographing method 800 can be implemented in the photographing apparatus 300 or the photographing apparatus 500 described above.

As shown in FIG. 11, at 801, the selection process is performed on the live-view image in the live view in real-time based on the aesthetics rule to determine the score of the live-view image. The process at 801 can be implemented in the image selection circuit 303 of the photographing apparatus 300 or the processor 502 of the photographing apparatus 500 described above, and detailed description thereof is omitted herein.

At 802, the photographing operation is automatically triggered, according to a combination of the score of the live-view image and one or more other criteria. In some embodiments, the photographing operation can be automatically triggered, when the object with the specific semantic is detected in the current scene and the score of the live-view image is higher than the threshold. The specific semantic can include, but is not limited to, e.g., people, animal, face, or smile. In some embodiments, the photographing operation can be automatically triggered, when the change of the depth of the current scene is detected and the score of the live-view image is higher than the threshold. In some embodiments, the photographing operation can be automatically triggered, when the change of the focus of the current scene is detected and the score of the live-view image is higher than the threshold. In some embodiments, the photographing operation can be automatically triggered, when the voice command is received and the score of the live-view image is higher than the threshold. In some embodiments, the photographing operation can be automatically triggered, based on a combination of the control process and the score of the live-view image. The control process can include the timer photographing, the time-lapse photographing, or the like.

The process at 802 can be implemented in the capture selection circuit 302 of the photographing apparatus 300 or the processor 502 of the photographing apparatus 500 described above, and detailed description thereof is omitted herein.

At 803, the captured image is automatically rotated. The process at 803 is similar to the process at 703, and detailed description thereof is omitted herein. The process at 803 can be implemented in the image rotation correction circuit 304 of the photographing apparatus 300 or the processor 502 of the photographing apparatus 500 described above.

At 804, the rotated image is automatically composed to generate the corrected image. The process at 804 is similar to the process at 704, and detailed description thereof is omitted herein. The process at 804 can be implemented in the image composition circuit 305 of the photographing apparatus 300 or the processor 502 of the photographing apparatus 500 described above, and detailed description thereof is omitted herein.

At 805, the corrected image is outputted. The process at 805 is similar to the process at 705, and detailed description thereof is omitted herein. The process at 805 can be implemented in the image display circuit 306 of the photographing apparatus 300 or the processor 502 of the photographing apparatus 500 described above, and detailed description thereof is omitted herein.

In some embodiments, the processes at 803 and/or 804 can be omitted. For example, when the process at 803 is omitted, the captured image can be composed directly. As another example, when the process at 804 is omitted, the rotated image can be outputted directly. As additional example, when the processes at 803 and 804 are omitted, the captured image can be outputted directly.

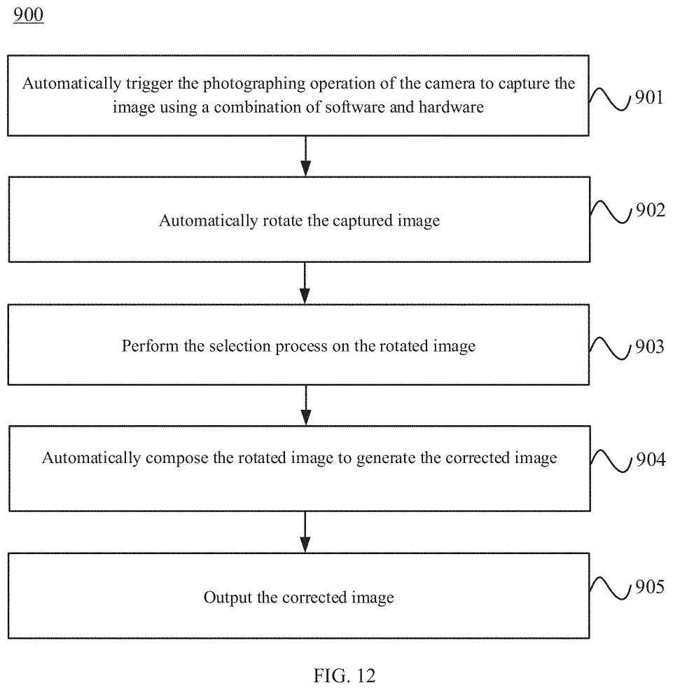

FIG. 12 is a flow chart of another example photographing method 900 consistent with the disclosure. The photographing method 900 can be implemented in the photographing apparatus 400 or the photographing apparatus 500 described above.

As shown in FIG. 12, at 901, the photographing operation of the camera is automatically triggered to capture the image using a combination of software and hardware. The process at 901 is similar to the process at 601, and detailed description thereof is omitted herein. The process at 901 can be implemented in the capture selection circuit 402 of the photographing apparatus 400 or the processor 502 of the photographing apparatus 500 described above.

At 902, the captured image is automatically rotated. The process at 902 is similar to the process at 602, and detailed description thereof is omitted herein. The process at 902 can be implemented in the image rotation correction circuit 403 of the photographing apparatus 400 or the processor 502 of the photographing apparatus 500 described above.

At 903, the selection process is performed on the rotated image. In some embodiments, a score of the rotated image can be determined according to the aesthetics rule. If the score is lower than the preset threshold, the rotated image can be discard. If the score is higher than the preset threshold, the rotated image can be kept for further process. In some other embodiments, at least one image feature can be extracted from the rotated image to determine the similarity between the rotated image and the images in the current album of the camera. If the score of the rotated image is lower than the lowest score or the highest score of the one or more similar images that are similar to the rotated image, the rotated image can be discard. If the score of the rotated image is higher than the lowest score or the highest score of the one or more similar images, the rotated image can be kept for further process. In some embodiments, the one or more similar images having scores lower than the score of the rotated image can be deleted from the current album.

The process at 903 can be implemented in the image selection circuit 404 of the photographing apparatus 400 or the processor 502 of the photographing apparatus 500 described above, and detailed description thereof is omitted herein.

At 904, the rotated image is automatically composed to generate the corrected image. The process at 904 is similar to the process at 603, and detailed description thereof is omitted herein. The process at 904 can be implemented in the image composition circuit 405 of the photographing apparatus 400 or the processor 502 of the photographing apparatus 500 described above.

At 905, the corrected image is outputted. The process at 905 is similar to the process at 605, and detailed description thereof is omitted herein. The process at 905 can be implemented in the image display circuit 406 of the photographing apparatus 400 or the processor 502 of the photographing apparatus 500 described above, and detailed description thereof is omitted herein.

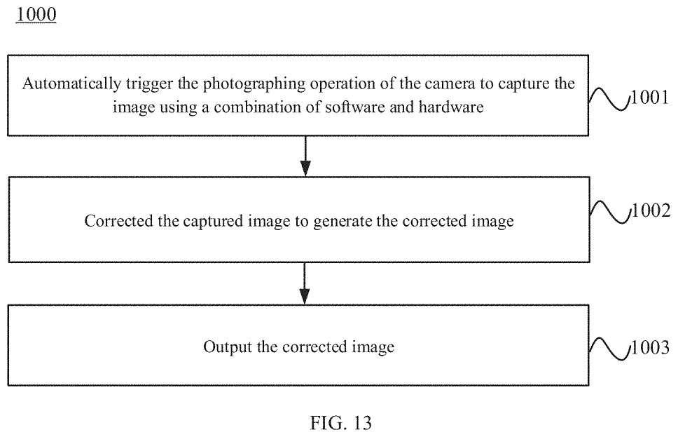

FIG. 13 is a flow chart of another example photographing method 1000 consistent with the disclosure. The photographing method 1000 can be implemented, e.g., in the photographing apparatus 500 described above.

As shown in FIG. 13, at 1001, the photographing operation of the camera is automatically triggered to capture the image using a combination of software and hardware. The process at 1001 is similar to the process at 601, and detailed description thereof is omitted herein. The process at 1001 can be implemented in the processor 502 of the photographing apparatus 500 described above.

At 1002, the captured image is corrected to generate the corrected image. In some embodiments, the selection process can be performed on the captured image, and the captured image after selection can be the corrected image. The selection process is similar to the selection process described in the process at 604, and detailed description thereof is omitted herein. In some embodiments, the captured image can be rotated to generate the corrected image (i.e., the rotated image). The rotation correction method is similar to the rotation correction method described in the process at 602, and detailed description thereof is omitted herein. In some embodiments, the captured image can be rotated to generate the rotated image, and the rotated image can be composed to generate the corrected image. The composition method is similar to the composition method described in the process at 603, and detailed description thereof is omitted herein. In some embodiments, the captured image can be composed to generate the corrected image. In some other embodiments, the distortion correction can be performed on the captured image or the rotated image.

At 1003, the corrected image is outputted. The process at 1003 is similar to the process at 605, and detailed description thereof is omitted herein. The process at 1003 can be implemented in the processor 502 of the photographing apparatus 500 described above, and detailed description thereof is omitted herein.

For simplification purposes, detailed descriptions of the processes of example methods may be omitted and references can be made to the descriptions of the example apparatuses.

The disclosed apparatuses and methods may be implemented in other manners not described here. For example, the apparatuses described above are merely illustrative. For example, the division of units may only be a logical function division, and there may be other ways of dividing the units. For example, multiple units or components may be combined or may be integrated into another system, or some features may be ignored, or not executed.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit.

Other embodiments of the disclosure will be apparent to those skilled in the art from consideration of the specification and practice of the embodiments disclosed herein. It is intended that the specification and examples be considered as illustration only and not to limit the scope of the disclosure, with a true scope and spirit of the invention being indicated by the following claims.

What is claimed is:

1. A photographing method comprising:
automatically triggering a photographing operation of a camera to capture an image using a combination of software and hardware;
automatically correcting the captured image to generate a corrected image; and
outputting the corrected image.

2. The method of claim 1, wherein correcting the captured image comprises:
composing the captured image to generate the corrected image.

3. The method of claim 2, wherein composing the captured image comprises:
detecting a salient object in the captured image;
obtaining position and size information of the salient object in the captured image;
cropping the captured image to obtain a composed image according to:
a composition rule,
position information of the salient object, and
size information of the salient object; and
scaling the composed image to obtain the corrected image.

4. The method of claim 3, wherein the composition rule includes at least one of:
a central composition rule, a triad composition rule, a horizontal line composition rule, a symmetric composition rule, or a diagonal composition rule.

5. The method of claim 2, wherein composing the captured image comprises:
obtaining a network model or a tree structure;
inputting the captured image;
processing the captured image according to the network model or the tree structure to obtain cropping coordinates and scaling factors;
cropping the captured image to obtain the composed image according to the cropping coordinates; and
scaling the composed image to obtain the corrected image according to the scaling factors.

6. The method of claim 5, wherein the network model is obtained by training based on a plurality of samples.

7. The method of claim 2, wherein correcting the captured image further comprises:
rotating the captured image before composing the captured image.

8. The method of claim 7, wherein rotating the captured image comprises:
obtaining attitude information of the camera, the attitude information including at least one of yaw axis information of the camera, pitch axis information of the camera, or roll axis information of the camera; and
rotating the captured image according to the attitude information of the camera.

9. The method of claim 7, wherein rotating the captured image comprises:
detecting a horizontal line in the captured image to obtain a tilt angle in a roll direction; and
when the tilt angle is smaller than a threshold, rotating the captured image in the roll direction according to the tilt angle.

10. The method of claim 7, wherein correcting the captured image further comprises:
performing a distortion correction on a candidate image, the candidate image being the captured image or the corrected image.

11. A photographing apparatus comprising:
a camera;
a processor coupled to the camera; and
a memory coupled to the processor and storing instructions that, when executed by the processor, cause the processor to:
automatically trigger a photographing operation of a camera to capture an image using a combination of software and hardware;
automatically correct the captured image to generate a corrected image; and
output the corrected image.

12. The apparatus of claim 11, wherein the instructions further cause the processor to:
compose the captured image to generate the corrected image.

13. The apparatus of claim 12, wherein the instructions further cause the processor to:
detect a salient object in the captured image;
obtain position and size information of the salient object in the captured image;
crop the captured image to obtain a composed image according to:
a composition rule,
position information of the salient object, and
size information of the salient object; and
scale the composed image to obtain the corrected image.

14. The apparatus of claim 13, wherein the composition rule includes at least one of:
a central composition rule, a triad composition rule, a horizontal line composition rule, a symmetric composition rule, or a diagonal composition rule.

15. The apparatus of claim 12, wherein the instructions further cause the processor to:
obtain a network model or a tree structure;
input the captured image;
process the captured image according to the network model or the tree structure to obtain cropping coordinates and scaling factors;
crop the captured image to obtain the composed image according to the cropping coordinates; and
scale the composed image to obtain the corrected image according to the scaling factors.

16. The apparatus of claim 15, wherein the network model is obtained by training based on a plurality of samples.

17. The apparatus of claim 12, wherein the instructions further cause the processor to:
rotate the captured image before composing the captured image.

18. The apparatus of claim 17, wherein the instructions further cause the processor to:
obtain attitude information of the camera, the attitude information including at least one of yaw axis information of the camera, pitch axis information of the camera, or roll axis information of the camera; and
rotate the captured image according to the attitude information of the camera.

19. The apparatus of claim 17, wherein the instructions further cause the processor to:
detect a horizontal line in the captured image to obtain a tilt angle in a roll direction; and
when the tilt angle is smaller than a threshold, rotate the captured image in the roll direction according to the tilt angle.

20. The apparatus of claim 17, wherein the instructions further cause the processor to:
perform a distortion correction on a candidate image, the candidate image being the captured image or the corrected image.
